(19) United States
(12) Patent Application Publication
(10) Pub. No.: US 2006/0009989 A1
(43) Pub. Date: Jan. 12, 2006

(54) Method, apparatus, data structure and system for scheduling work consistent with an entity's strategic objectives

(75) Inventor: John K. McCormick, West Band, WI (US)

Correspondence Address: JOHN K. MCCORMICK, 6781 GLACIER DRIVE, WEST BEND, WI, 53090, US

(73) Assignee: Strategic Foresight LLC, West Band, WI (US)

(21) Appl. No.: 10/710,385

(22) Filed: Jul. 6, 2004

(51) Int. Cl. G06Q 99/00

(52) U.S. Cl. 705/1

(57) ABSTRACT

A method, apparatus, data structure and system for scheduling work consistent with and supportive of the strategic objectives of an entity is disclosed herein. In its preferred embodiment, the strategic objectives are defined and the primary strategic objective is chosen along with a measure for the primary strategic objective. Next, a measure for scheduling work is defined and chosen that is consistent with the primary strategic objective and the objective's measure. Next, the constraints to schedule work by are evaluated, the primary constraint selected and the order within the chosen constraint prioritized. The work schedule measure is then calculated for each job in the work queue for the selected constraint. All of the jobs are sorted based upon the calculated work schedule measures with the job having the largest positive impact on the work schedule measure being first. The prioritized job is then scheduled into the prioritized constraint.

### SUMMARY OF INVENTION

A need has arisen for a means that allows for the scheduling of work in a manner that is consistent and supportive with the primary strategic objective of any given entity. The present invention provides for such a means for scheduling work that is consistent with the primary strategic objective of an entity. As such, the proposed invention makes the assumption that an entity has, in fact, a strategic plan and strategic objectives. The present invention improves the probability of succeeding in achieving the strategic objective of an entity by assuring that the scheduled work activity is scheduled to best support the achievement of the strategic objective.

The present invention also recognizes that there are tradeoffs to be made in scheduling work to be supportive of the primary strategic objective and allows for those tradeoffs to be balanced against the strategic objective. The present invention further recognizes that scheduling the work in order to align it with the primary strategic objective may not be desirable or necessary and, as such, the present invention may be utilized as to secondary strategic objectives instead.

### BACKGROUND ART

Prior to the Industrial Revolution, people worked in groups of skilled trades. There existed a master and his apprentices. The apprentices worked for years to learn the trade and become a master in their own right. At that time, products and services were generally built or provided by hand, one piece at a time. Then, due to ingenuity and invention, the Industrial Revolution started taking place. Along with this came many and numerous benefits. Some of these, among many, included breaking the work down into smaller sections so that people worked and became a specialist on only a part of the whole job. Other benefits included the automation of many of the jobs for greater efficiency, the creation of consistency between parts so that they were interchangeable, and many other benefits. However, one of the consequences of this revolution was the replacement of the prior crafts with production factories.

The advent of the production factories created many more benefits, such as reduced costs and higher production. This resulted in greater sales, more growth and the development of more products and services for consumers. However, it also created many new problems to be addressed. Of the myriad of problems created, three of these included the issues of how to order material for all of the jobs currently being run as well as for the future expected jobs, how to decide how many parts to run at a given time and how to schedule multiple jobs on a limited number of machines and work stations. With perseverance and ingenuity, someone or a group of people created what is now known as MRP and MRP II. MRP stands for Material Requirements Planning, and MRP II stands for Manufacturing Resource Planning.

MRP was a wondrous development in that it looked at what was on order and what the historical usage of a specific material was in order to predict what the likely use of that same material would be in the near future. This allowed the people in charge of purchasing material to be better equipped to order material without ordering too much or not ordering enough for the foreseeable future. The advent of MRP II, however, was even better, and it helped to modify MRP to be better as well. What MRP II did was to look at all of the sales forecast for completed products, the existing orders for those products and at the historical demand for the completed products, the subcomponents, the individual parts, and the raw material usage for all of that. It also looked at the time it took to setup and run jobs as well as the availability of equipment and fixtures to run those jobs. From all of this data, MRP II was able to determine many things. For example, MRP II could calculate the number of hours of work that was required on each specific machine or work station in order to complete the existing and forecasted work load. This is known today as the machine load. This in turn could be used to forecast future needs for manpower and equipment requirements.

The developer(s) of MRP II also created what is called the EOQ, or Economic Order Quantity. This is the number of parts or units a person is to purchase, work on and/or build in a single lot, or production run, in order to keep the costs at a minimum. In short summary, the EOQ looks at the most recent history of the usage of a given part or material and the current amount required for existing and forecasted orders. Then the EOQ formula balances the costs of ordering a part or unit against the cost of carrying the part or unit in inventory over time. This formula and terminology is well know in the art and has been in use for decades. It is utilized in all kinds of business' and industries, including manufacturing, distribution, service companies, governmental agencies and so on.

In addition to providing the EOQ for a given part or unit, the MRP II system also provided a method for scheduling jobs onto machines or work stations. That logic was, and still is, based upon getting the oldest order in the facility out first. Why the original developers of MRP II wanted to schedule jobs based upon getting the oldest order out first is unknown to this author, however, that was the method used in the past and is still in use today. Interestingly, while the EOQ was developed and focused on minimizing the total costs, the scheduling of the oldest order first is probably not the most cost effective job to run first, since the oldest in-house order is usually oldest for a good reason. Those reasons typically being such things as the oldest order is very low volume work, or difficult to do or not a very cost effective or profitable job to run. At any rate, the methodology employed to schedule jobs begins by sorting the existing job orders by the oldest outstanding unfulfilled job order first, and then scheduling that oldest job order into purchasing or onto the next available machine or work station for processing.

Then during the 1960's, 1970's and 1980's, business conditions began to change. Computer systems became more readily available for business and individual use. This allowed for the automation of many business and industry processes resulting in reduced costs and greater information flows. Transportation and communication processes also improved greatly with the result that global trade started expanding at a furious pace. This resulted in greater competition at the national and local levels. Initially, the natural response to this increased international competition was to focus an organization on reducing costs and becoming more cost competitive. While the focus on cost reduction had some positive impact, it became obvious that cost reduction alone would not be sufficient for the survival and growth of many companies and industries.

For example, in the United States today a manufacturer or distributor may be paying $15.00 to $25.00 or more per hour for a laborer, while in China that same laborer is getting paid less than $1.00 per hour. Obviously, given the differing wage rates, it is very unlikely that a United States company can compete with an identical company located in China on costs. As a result, many companies have switched their primary strategic focus from cost reduction to some other strategic advantage.

For example, in the 1970's and 1980's the quality improvement initiative became a main focus for competitive improvement. By improving the quality of the products and services, companies could not only produce a better product or service, but they could reduce costs as well by reducing or eliminating the waste and inefficiencies in the existing products and services. This quality effort was driven and sustained throughout the 1980's and most of the 1990's. It is still in use today, although not at the same strategic priority it was just a few years ago. Another significant effort was the development of a just-in-time (JIT) operating structure. This strategic priority was characterized by reducing as much of a company's in-house inventory of materials and supplies as possible while having their suppliers carry the inventory and deliver it only when the materials were needed. This not only reduced the floor space required but also improved the cash flow and reduced the long term investment in inventory. However, any quality problems or forecasting usage errors caused delays in providing goods and services to the end customers.

Another strategic direction was to dramatically improve the response time to customer's demands without carrying the inventory. One of the more recent efforts to achieve this end was the method of redesigning the processes and products in order to effectively build one piece at a time, based solely on the incoming orders. Although it has had limited success, it is an attempt to by-pass the part order cost versus the inventory carrying cost of the old EOQ formula and to avoid the problem of scheduling the oldest order first in order to focus on the strategic objective of reducing lead-times to customers. This method has proven difficult and sometimes impossible to implement and has seen very limited success and application in the marketplace.

As global competition continues to increase, industry and business entities worldwide continue to develop new strategic directions and endeavors in order to meet this increased competition in order to survive and grow. While low costs are still an important issue to manage for any business, it is no longer the sole strategic objective to be managed. In fact, it may no longer even be the primary issue that drives a business. Many companies have realized that there are other strategic objectives that, if properly implemented, can succeed in the global economy. Some of these objectives include having a much faster response time to customer demands, developing new products in a more timely fashion, or acquiring more market share and distribution channels, just to name a few. Still other companies that are struggling to survive have had to focus on managing cash flow as their primary focus.

Unfortunately, the MRP II system that was developed decades ago is still in use today. There are no other substitutes or alternatives for MRP II other than manually planning and scheduling work. As such, work schedules are still being determined by scheduling the oldest order first, whether or not the oldest order has any relevance at all to the strategic objectives that a company is trying to drive its business by. For example, if a business has decided that its primary strategic objective is to substantially reduce lead-times to customers, then scheduling by the oldest order first is not the best method to minimize lead-times. Instead, it would be more beneficial to schedule the work based upon minimizing the lead-times to customers.

Similarly, if a company is in financial trouble and needs to manage its cash flow, scheduling the work by the oldest order is not the best way to improve the cash flow. Instead, scheduling work by those jobs which have the biggest positive impact to cash flow would be much more relevant. The same logic applies whether a company's primary strategic objective is increasing market share, improving the company's EBIT (Earnings Before Income Tax), assuring new products are available for a planned sales promotion, or any other strategic direction that a company chooses to pursue. The means for scheduling work should support and be consistent with the primary strategic objective that a company has set, not by just an arbitrary oldest order first mentality. This is as true for a manufacturing business as it is for a service company, a governmental agency or any other endeavor that has a strategic plan and desires to schedule work in accordance with its strategic priorities.

A technical problem in connection with strategic planning and operational activities is that there is no knowledge of an effective means for determining the optimal activity and/or work schedule that optimizes the work schedule to be consistent with and supportive of the strategic objective of an entity. Furthermore, there is no technical way of evaluating any existing or proposed changes to the work schedule to determine how the work schedule impacts the strategic objective of an entity. As such, a need exists for a means for the scheduling of work that corresponds to the strategic objective.

### BEST MODE FOR CARRYING OUT THE INVENTION

To facilitate the description of the invention, it is worthwhile to define some terminology solely for this purpose. This terminology is somewhat arbitrary and should not be construed as limiting the generality of the invention. For the purposes of this description:

1. Planning period is a time frame meant to include the existing orders or work schedule, however the planning period could use or include the current forecastable planning period and/or any other planning period, including a historical planning period, chosen by the user.

2. Dependant work is work where there are two or more different jobs or orders that must use the same workstation, machine, operator, tooling, fixturing and/or the same material and a choice must be made as to which job or order will get the workstation, machine, operator, tooling, fixture and/or the material first. Dependant work could also include customer orders wherein the customer order must be completed as a whole order and not in partial order fulfillment.

3. Independent work is work where there are two or more different jobs or orders that use different workstations, machines, operators, tooling, fixtures and/or materials such that the jobs or orders can be fulfilled separately from each other.

4. Work is meant to include any endeavor that the entity puts resources into in order to accomplish some desired result. Work could be such things as consulting, legal aid, purchasing, check processing, health care, production, filming art and a myriad of other activities.

5. Constraints are meant to include those aspects of the business that hinder the completion of work in any manner and therefore must be managed or the work scheduled against.

6. Work queue or job queue refers to the totality of actual or forecasted jobs, orders and/or work that is anticipated to be accomplished in the planning period.

Reference will now be made in detail to the description of the invention as illustrated in the drawings. Although the invention will be described in connection with these drawings, there is no intent to limit the invention to the embodiment or embodiments disclosed therein. On the contrary, the intent is to include all alternatives, modifications and equivalents included within the spirit and scope of the invention as defined by the appended claims.

Furthermore, the order of the itemized steps in FIG. 2 and FIG. 3 are not meant to limit the scope of the invention to the specific itemized order of those steps, but rather to include those steps in any relevant order including any alternatives, modifications and equivalents included within the spirit and scope of the invention as defined by the appended claims.

To aid in the understanding of the invention, examples of some of the specific itemized steps are provided for clarification purposes only. These examples are not meant to limit the invention to the process of developing work schedules based upon the strategic objectives used in the examples or only to businesses, but rather to include determining work schedules based upon any strategic objective, of any scope, for any entity, including any alternative, modification and equivalents included within the spirit and scope of the invention as defined by the appended claims.

FIG. 1 illustrates a system for determining the appropriate work schedule to be consistent with the strategic objective of an entity in accordance with the present invention. The apparatus 1 used to determine the appropriate work schedule may be embodied in any computing device, such as a personal computer or work station, as modified to carry out the features and functions of the present invention. As shown in FIG. 1, the system contains a processor 2, such as a central processing unit (CPU), and memory 3, such as RAM and ROM. Stored in the memory 3 are databases 4 and the Management Information System (MIS) 5. Within the MIS 5 are a variety of software programs including a Materials Requirement Planning (MRP) 6 module, Manufacturing Resource Planning (MRP II) 7 module and the software code for carrying out the features and functions of this invention 8.

In an alternative embodiment, multiple computing devices 1 could be utilized to host and accomplish whole parts, or individual portions, of the processor 2, memory 3, and/or MIS 5 software.

As shown in FIG. 2, the process for determining the appropriate work schedule for a given list of jobs starts with establishing the strategic objectives 9 for the entity. In its preferred embodiment, once the strategic objectives 9 are defined, the entity's strategic objectives 9 are prioritized 10 and a primary strategic objective 11 identified. Following the determination of the primary strategic objective 11 a list of possible measures 12 for the primary strategic objective 11 are developed and the primary measure 13 for the primary strategic objective 11 is selected.

It is important to prioritize 10 and select the primary the strategic objective 11 as different strategic objectives 9 may have different and/or conflicting measures. For example, if there were two strategic objectives 9, one to improve profitability and another to reduce product lead-times, the measure for improving profits might be something like monitoring the earnings before income taxes (EBIT) while the measure for reducing lead-times might be something like monitoring the average lead-time per customer order. If the primary strategic objective 11 was selected to be reducing lead-times, it is possible that actions taken could reduce lead-times and improve EBIT. However, it is just as possible that actions taken to reduce lead-times, say by increasing available on-hand inventory, could reduce the EBIT. As such, it is important to this invention that the strategic objectives 9 be prioritized 10 and the primary strategic objective 11 selected.

In a similar fashion, choosing the appropriate measure 13 for the primary strategic objective 11 is important to this invention. For example, if a primary strategic objective 11 is to improve profitability, there are a wide variety of measures 12 that could be selected as the primary measure 13. Those measures 12 could be such things as EBIT, dollars of gross profit, dollars of net profit, percent gross margin, percent net margin, return on investment (ROI), average dollar profit per customer or per product line, or a host of other possible measures 12. Clearly, these differing measures 12 could show conflicting results. For example, if the number of customers fell significantly but the remaining customers purchased higher margin products, then the average profit per customer could show an increase even though the total EBIT and the dollars of net and gross profit fell.

Similarly, if the primary strategic objective 11 was reducing lead-times, the measures 12 could be the average number of days to ship an order, the average number of orders shipped per day or a host of other lead-time related measures 12. It is important to realize that these two aforementioned measures can yield different results. For example, a company could increase the average number of orders it ships in a day and not reduce the number of days it takes to ship an order. Similarly, a business could reduce the average number of days it takes to ship an order and still not ship any more orders per day on average.

Once the primary strategic objective 11 and its corresponding measure 13 have been determined, the next objective is to define the measure 15 that will be utilized to schedule the work consistent with the primary strategic objective 11. In its preferred embodiment, the measure 15 for scheduling work would be the same as that used for monitoring the primary strategic objective 11, but measured on a per part or per order basis. For example, if the selected primary strategic objective 11 was to improve profitability, it has already been shown earlier that there are a multitude of measures that could be listed to measure 12 profitability. An entity could use EBIT, dollars of gross profit, dollars of net profit, percent gross margin, percent net margin, return on investment (ROI), average dollar profit per customer or per product line, or a host of other possible measures 12 for the primary strategic objective 11. If the entity chose the dollars of gross profit or the percent of gross margin for the company to monitor the primary strategic objective 11 on, then the same measure 13 could be readily used to schedule work by using the measure 15 of dollars of anticipated gross dollar profit per part or per order, or the entity could use the percent gross margin per part or per order.

However, when an entity is unable to convert the primary strategic objective measure 13 directly into the measure 15 for setting the schedule of the work to be done on a per part or per order basis, then a different measure 15 must be chosen that is consistent with and supportive of the primary strategic objective 11 and its measure 13. For example, if the primary strategic objective 11 was to improve the company's EBIT and the primary strategic objective measure 13 was chosen to be the entity's EBIT, it is very unlikely that the entity would be able to measure 13 each job and/or order within the entity by each individual job and/or order's EBIT directly. As such, the available measures 14 for the purposes of scheduling work might be such measures 14 as average gross margin per customer, average gross margin per order, average gross margin per job, the average dollar profit per job, the average margin percent per customer or a host of other possible measures 14. The entity should begin by listing the possible measures 14 for scheduling work that are consistent and supportive of the strategic objective 11, and then select the measure 15 the entity deems is most appropriate for its primary strategic objective 11.

Choosing the appropriate strategic objective measure 13 and the measure 15 for scheduling the work is important to the entity if the entity desires to assure that the scheduling of work is done consistently with the primary strategic objective 11. Choosing the wrong primary strategic objective 11 and/or the wrong primary strategic measure 13 and/or the wrong measure 15 for scheduling work may result in achieving unintended and undesirable consequences.

After the measure 15 for scheduling work has been chosen, consistent and supportive of the primary strategic objective measure 13, the next step is to choose the constraint 17 against which the work will be scheduled. To accomplish this, the entity must first list what the possible constraints 16 could be to schedule work by. Generally, the constraints 16 can be classified into one of four broad categories. These four broad categories are the manpower, the machine, the material and/or the tooling, fixtures and supplies, although there can be other constraints as defined by the entity. In most manufacturing companies today, MRP II 7 schedules work against the constraint 16 of a machine or a workstation once MRP II 7 determines that there is available material 16 for the necessary work. In other words, MRP II 7 looks at all of the jobs needed to be run, and the available material, and schedules those jobs with available material onto the machine or workstation where the jobs need to be run next. Typically, MRP II 7 does not check to see if there is available manpower and/or tooling, fixtures and supplies. MRP II 7 just assumes that the manpower, tooling, fixtures and supplies are available. As stated earlier, MRP II 7 prioritizes and schedules the jobs based upon the oldest order being scheduled first.

In choosing the constraint 17 against which the jobs will be scheduled, one must also choose the order of those constraints 18 for scheduling. For example, if the machine was chosen as the constraint 17 by which jobs will be scheduled, then one must determine which machine gets scheduled first. FIG. 3 is helpful at this point to illustrate how to define the order of the constraints within which to schedule work by 18. To determine the order 29 that the constraints should be scheduled in, the measure for the desired result 27 of the primary strategic objective 11 must be determined. This is accomplished by first listing the possible measures 26 for the results of the primary strategic objective 11 and then choosing one of those measures 27 as the strategic objective result measure. The next step is to calculate the strategic result measure 28 for each sub-element within the chosen constraint 28. The calculated result measures are then prioritized 29 with the sub-element constraint having the largest positive impact on the strategic objective result measure being first.

For example, if the primary strategic objective 11 was chosen to be reducing lead-times, one of the questions that must be answered is: does the entity want to get orders out faster or does the entity want to get more orders out in the same time frame. Note that these two issues do not necessarily result in the same outcome. It is quite possible to find a means to get more orders out in a day and yet not reduce the lead-times for any job. Similarly, it is very possible to reduce the lead-times of many jobs and still not ship any more jobs per day than was shipped in the past.

If an entity chose getting orders out faster, then the order of the constraint 18 to schedule against would be the man, machine, fixture or whatever constraint 17 selected that has the greatest order per load ratio on it. For example, if reducing lead-times was the strategic objective 11 and the desired result 26 was to get orders out faster and the machines were chosen as the constraint 17, then the machine with the greatest number of orders per machine load hours should be scheduled first for the planning period. The reason for this is that this measure 27 is determining the amount of time per order.

On the other hand, if reducing lead-time was the strategic objective 11 and an entity chose getting more orders out per day and the machines were chosen as the constraint 17, then the machine with the greatest number of orders tied to that machine should be scheduled first. The reason for this is that the measure 27 is determining the machine with the greatest number of orders and not the amount of time those orders consume.

The same approach is utilized regardless of the strategic objective 11 chosen or of the type of entity or endeavor. Whether the primary strategic objective 11 is improving profits or increasing sales or any number of other possible choices, once the constraint 17 to schedule work against has been chosen, determining the order for scheduling the constraints 18 must be established. That is accomplished by choosing a measure 27 for the constraint 17 that is consistent with the desired results of the primary strategic objective 11. While the selection of one of the strategic objective measures 27 would preferably be the same as the measure for the strategic objective 13, they may not necessarily be the same. Once selected, the strategic objective result measures 27 are then calculated 28 for each individual element within the constraint. For example, if the chosen constraint 17 is the machine, then the strategic objective result measure 27 is calculated for each machine within the entity. Once the results 28 are calculated for each sub-element within the constraint 17, the results are prioritized 29 for each of the elements within the constraint 17, with the constraint sub-element having the largest impact on the desired strategic objective result 29 being first.

Going back to FIG. 2, a manufacturing or a non-manufacturing entity can choose to schedule work against any constraint 17 that it so desires. For example, a distribution company could choose to schedule against the available material handling equipment or a software company could schedule work against the availability of software programmers. One business that this author is aware of was forced to schedule work based upon the availability of storage space to hold work-in-process and finished goods. That business made subassemblies that were very large and the orders for them came in very sporadically. However, when the orders did come in, the orders were for a large quantity of the subassemblies. As a result, there was a lot of available storage space when there were no orders for the specific subassemblies and an insufficient amount of storage space when the orders did arrive. Therefore, the company chose to schedule work by available storage space rather than add additional storage space.

Once the measure for scheduling work 15 is defined and the constraint 17 selected and prioritized 18, the next step is to calculate the work scheduling measure 19 for each job or order that is in the work queue that has material available for each job. If a given customer order has multiple jobs associated with it and the customer order cannot be finalized and/or shipped until all of the jobs for a given customer order are completed, the process must cumulate all of the work scheduling measures for each job that is associated with a specific customer order. If partial shipments or partial customer order job completions are allowed, then each job or customer order subset of jobs can be treated individually and not cumulated to the total customer order. The calculation for each job and/or order is done for the entire time within the planning period desired to be scheduled.

For all of the work that is independent, per the definition above, to all of the other work in the work queue, those jobs and/or orders can be scheduled 20 and run immediately as they are independent of all other jobs as defined by the constraints 17. For all of the dependant jobs in the work queue for the planning period, the next step is to sort the dependant jobs 21 and/or orders based upon the work scheduling measure 15 determined above. For example, if the primary strategic objective 11 was to improve profitability, and the measure for scheduling work 15 was gross dollar profit, then the first step would be to calculate 19 the gross dollar profit for each job and/or order that could be fulfilled. If there are multiple jobs to a given customer order and no partial fulfillments are allowed, then the gross dollar profit for the entire customer order must be calculated 19. If partial fulfillments are allowed, then the gross dollar profit for each of the partial fulfillments must be calculated 19 separately. Once this has been determined for each job and/or order in the planning period, the jobs and/or orders would then be sorted 21 with the largest gross dollar profit job and/or being first.

As another example, if the primary strategic objective 11 was reducing lead-times for customer orders and the measure for scheduling work 15 was chosen to be lead-time until order completion, the lead-time for each dependant job and/or order would be determined and cumulated 19. All of the independent jobs and/or orders could then be scheduled 20 since they would not impact any other job. The dependant jobs and/or orders would then be sorted 21 in ascending order by the chosen constraint 17. Thus, if the chosen constraint 17 was the machine, the jobs and/or orders would be sorted 21 ascendingly by machine.

The next step is to schedule the work on the prioritized machine based upon the work with the biggest cumulative impact 22 to the chosen work scheduling measure 15. For example, continuing with the lead-time example in the prior paragraph, the first job to be run would be the job on the priority machine that has the least amount of cumulative lead-time. As another example, if the primary strategic objective 11 was improving profits and if the work schedule measure 15 was gross dollar profit, the job with the greatest amount of gross dollar profit would be scheduled first.

The next step is to remove that job and/or order 23, along with all other orders that do not require any other parts and/or orders from the work scheduling queue. Next, take the cumulative impact from the order(s) just removed from the work schedule queue and add that impact to all of the remaining cumulative jobs and/or orders remaining in the queue 24. For example, if the work schedule measure 15 was gross dollar profit and the job or order with the largest impact had an impact of $100 to the gross dollar profit, after scheduling that job first and removing that same job from the work schedule queue, then $100 would be added to the gross dollar profit of each of the remaining jobs in the work schedule queue.

The next step is to return to the step wherein the order of the constraints for scheduling work by was defined 18 and continue with this process until all of the jobs have been scheduled through all of the constraints.

In an alternate embodiment, once the first constraint has been defined 18, and the work schedule measure calculated for each job and/or order within the work queue for the prioritized constraint 19, and the dependant jobs sorted 21, then all of the jobs sorted could be scheduled for that constraint and other constraints thereby connected to those scheduled jobs. Upon scheduling all of those jobs, the jobs would be removed from the job queue and the process begins again for defining the remaining order of the constraints to schedule work by 18.

In an additional embodiment, the original MRP II 7 work schedule based upon scheduling the oldest order first can be compared to the new schedule created by the present invention to determine the magnitude and consequences of the new work schedule 27.

A need therefore exists for a method and an apparatus that allows an entity to schedule work in a manner that is consistent with and supportive of the entity's strategic objective, when the entity's strategic objective is not the maintenance or reduction of costs.

I claim:

### BRIEF DESCRIPTION OF THE DRAWINGS

For a further understanding of the nature and objects of the invention, reference should be made to the following description and appended claims, taken in conjunction with the accompanying drawings, in which like elements are given the same reference numbers. It is to be understood that these drawings depict only the typical embodiments of the invention and are, therefore, not to be construed as limiting the scope and spirit of the invention.

FIG. 1 illustrates a system in accordance with the present invention;

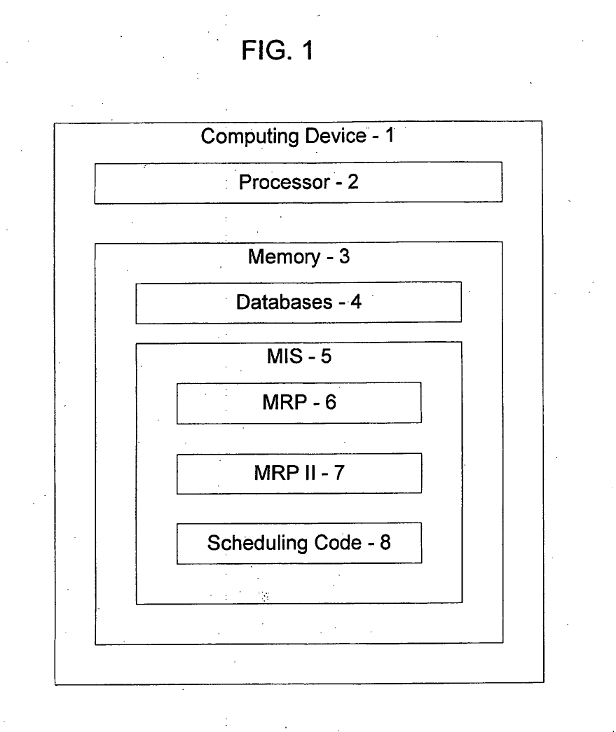

FIG. 2 is a flow chart describing an exemplary job and/or order work scheduling process; and

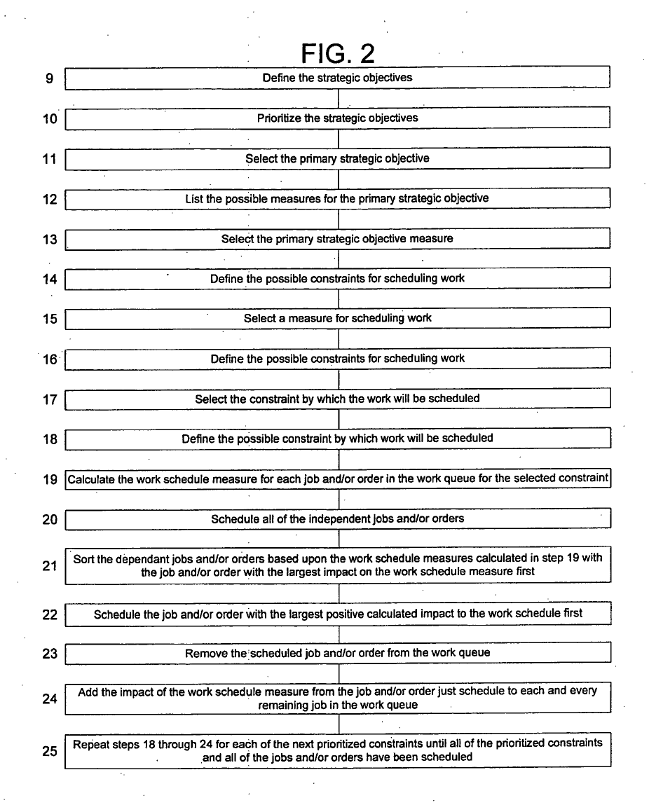

FIG. 3 is a flow chart of a means for defining the order of the constraints to schedule work by.

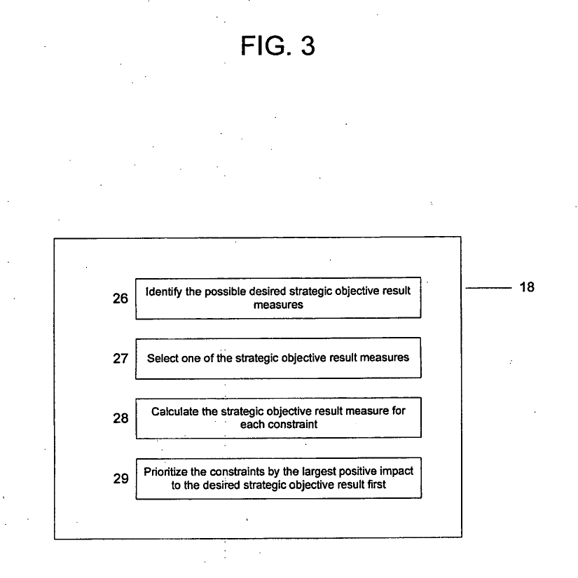

1. A method for scheduling activities and/or work consistent with an entity's strategic objective, wherein said method comprises the steps of:
a. defining the strategic objectives;
b. prioritizing the said strategic objectives;
c. selecting the primary strategic objective;
d. listing the possible measures for the said primary strategic objective;
e. selecting the primary strategic objective measure;
f. scheduling all of the independent jobs and/or orders;
g. defining the possible measures to be used for scheduling work consistent with the said primary strategic objective measure;
h. selecting a primary measure for said scheduling of work consistent with the said primary strategic objective measure;
i. defining the possible constraints for scheduling said work;
j. selecting the constraint by which said work will be scheduled;
k. prioritize the order of the constraints to schedule said work by;
l. calculating the said work schedule measure for each said job and/or order in the work queue for the said prioritized constraint;
m. sorting the dependant jobs and/or orders based upon the said work schedule measures with the said job and/or order that has the largest positive impact on the said work schedule measure first;
n. scheduling the job and/or order with the said largest positive impact on the said work schedule measure on the said prioritized constraint first; and
o. repeating steps k through n for each of the said constraints until all of the said constraints and all of the said jobs and/or orders have been scheduled.

2. A method as recited in claim 1, wherein the said method of prioritizing the order of the constraints comprises the additional steps of:
a. removing the said scheduled job and/or order from the said work queue; and
b. adding the impact of the said work schedule measure from the said scheduled job and/or order to the said impact of each of the said jobs and/or orders remaining in the said work queue.

3. A method as recited in any one of claims 1 through 2, wherein the said method of prioritizing the order of the constraints comprises the additional steps:
a. identifying the possible desired strategic objective result measures;
b. selecting one of the said desired strategic result measures;
c. calculating the said selected strategic result measure for each of the said constraints; and
d. prioritizing the said selected strategic result measures for each of the said constraints with the said constraint having the largest positive impact being first.

4. A method as recited in any one of claims 1 through 3 wherein any strategic objective is used.

5. An apparatus for scheduling work consistent with an entity's strategic objective, wherein said apparatus includes:
a. a memory that stores computer-readable code;
b. a processor operatively coupled to said memory, said processor configured to implement said computer-readable code, said code configured to:
i. calculate the desired strategic objective result measure for each constraint for the planning period;
ii. prioritize the said calculated strategic objective result measures for scheduling work;
iii. calculate the work schedule measure for each job and/or order in the work queue for the prioritized constraints;
iv. schedule all of the independent jobs;
v. sort the dependant jobs and/or orders of the highest priority constraint based upon the said work schedule measures with the said jobs and/or orders having the largest positive impact on the said work schedule measure first;
vi. scheduled the said dependant job and/or order with the said largest positive impact first; and
vii. repeating steps i through vi until all of the said constraints and all of the said jobs and/or orders have been scheduled for the planning period.

6. An apparatus as recited in claim 5, wherein the said apparatus includes a said processor operatively coupled to said memory, said processor configured to implement said computer-readable code, said code configured to:
a. remove the said scheduled job and/or order from the said work queue; and
b. add the said impact of the said scheduled job and/or order to the said impact of the jobs and/or orders remaining in the said job and/or order queue.

7. An apparatus as recited in any one of claims 5 through 6, wherein the said apparatus includes a said processor operatively coupled to said memory, said processor configured to implement said computer-readable code, said code configured to:
a. calculate the strategic objective result measure for each said constraint; and
b. prioritize the said constraints by the largest positive impact to the said strategic objective result measure being first.

8. An apparatus as recited in any one of claims 5 through 7 wherein any strategic objective is used.

9. A computer program embodied on a computer-readable medium for determining the sequence or order for scheduling activities or work that is consistent with and supportive of the entity's primary strategic objective such that the operational side of the entity is supporting and consistent with the said strategic direction of the entity, wherein said determination comprises a data structure instantiating code segment that establishes a storage record in memory having:
a. the calculations for the primary strategic objective measure and for the work schedule measure that are consistent;
b. prioritized constraints for scheduling work by;
c. the calculated work schedule measure for each said activity or work in the work schedule for the said prioritized constraints;
d. a work schedule of the dependant activities or work in the said work schedule, sorted by the activity or work with the largest impact on the said work schedule measure of the said prioritized constraints first; and
e. repeating steps i through iv for each of the said constraints until all of the said constraints and all of the said activities or work have been scheduled.

10. A computer program embodied on a computer-readable medium as recited in claim 9, wherein the said new order and/or lot size comprises a data structure instantiating code segment that establishes a storage record in memory that:
a. has removed the scheduled activity or work; and
b. adds the impact of the said work schedule measure from the said scheduled activity and/or work to the said impact of each of the said activities and/or work remaining in the said work queue.

11. A computer program embodied on a computer-readable medium as recited in any one of claims 9 through 10, wherein the said new order and/or lot size comprises a data structure instantiating code segment that establishes a storage record in memory that:
a. calculates the selected strategic result measure for each of the said constraints; and
b. prioritizes the said selected strategic result measures for each of the said constraints with the said constraint having the largest positive impact being first.

12. A computer program embodied on a computer-readable medium as recited in any one of claims 9 through 11, wherein the said new order and/or lot size comprises a data structure instantiating code segment that establishes a storage record in memory wherein any strategic objective is used.

13. A device and system for scheduling activities and/or work consistent with an entity's strategic objective, said device and system comprising:
a. a means for defining the strategic objectives;
b. a means for prioritizing the said strategic objectives;
c. a means for electing the primary strategic objective;
d. a means for listing the possible measures for the said primary strategic objective;
e. a means for selecting the primary strategic objective measure;
f. a means for scheduling all of the independent jobs and/or orders;
g. a means for defining the possible measures to be used for scheduling work consistent with the said primary strategic objective measure;
h. a means for selecting a primary measure for said scheduling of work consistent with the said primary strategic objective measure;
i. a means for defining the possible constraints for scheduling said work;
j. a means for selecting the constraint by which said work will be scheduled;
k. a means for prioritize the order of the constraints to schedule said work by;
l. a means for calculating the said work schedule measure for each said job and/or order in the work queue for the said prioritized constraint;
m. a means for sorting the dependant jobs and/or orders based upon the said work schedule measures with the said job and/or order that has the largest positive impact on the said work schedule measure first;
n. a means for scheduling the job and/or order with the said largest positive impact on the said work schedule measure on the said prioritized constraint first; and
o. a means for repeating steps k through n for each of the said constraints until all of the said constraints and all of the said jobs and/or orders have been scheduled.

14. The means of claim 13, wherein the said means of prioritizing the order of the constraints comprises:
a. a means for removing the said scheduled job and/or order from the said work queue; and
b. a means for adding the impact of the said work schedule measure from the said scheduled job and/or order to the said impact of each of the said jobs and/or orders remaining in the said work queue.

15. The means of any one of claims 13 through 14, wherein the said means of prioritizing the order of the constraints comprises:
a. a means for identifying the possible desired strategic objective result measures;
b. a means for selecting one of the said desired strategic result measures;
c. a means for calculating the said selected strategic result measure for each of the said constraints; and
d. a means for prioritizing the said selected strategic result measures for each of the said constraints with the said constraint having the largest positive impact being first.

16. The means as recited in any one of claims 13 through 15 wherein any strategic objective is used.
